(19) United States
(12) Patent Application Publication
(10) Pub. No.: US 2010/0279126 A1
(43) Pub. Date: Nov. 4, 2010

(54) CERAMIC SLABS AND A METHOD FOR MANUFACTURING THEREOF

(75) Inventor: Giovanni Pellicelli, Reggio Emilia (IT)

Correspondence Address: BROWDY AND NEIMARK, P.L.L.C.;624 NINTH STREET, NW, SUITE 300, WASHINGTON, DC, 20001-5303, US

(73) Assignee: GRANITIFIANDRE SOCIETA' PER AZIONI, CASTELLARANO (IT)

(21) Appl. No.: 12/679,186

(22) PCT Filed: Sep. 9, 2008
(86) PCT No.: PCT/EP2008/061907

§ 371 Date: Jul. 26, 2010

(30) Foreign Application Priority Data
Sep. 19, 2007 (IT) RE2007A000100

(51) Int. Cl. B32B 19/00; C04B 33/20; C04B 33/14; C01G 49/06

(52) U.S. Cl. 428/454; 264/681; 264/644; 423/633

(57) ABSTRACT

A method for production of ceramic slabs comprising a mixture of atomised ceramic powders and a mixture of alpha hematites.

### TECHNICAL FIELD

The invention relates to ceramic slabs in the form of tiles or tesserae which imitate natural stones, and a method for manufacturing thereof.

### BACKGROUND ART

It is known that research in the ceramic sector is directed at obtaining slabs or tiles which imitate marbles or natural stones.

Among the searched-for aesthetic aspects there are ceramic slabs which imitate marbles and stones exhibiting a uniformly-distributed surface speckling.

The present applicant has developed a method for manufacturing ceramic tiles having brilliant speckled aesthetic effects, like those which in natural stone is found in mica.

The above-mentioned method, described in Italian patent application RE2004A000116, includes using as a tile paste a mixture of atomised clay and very fine powder of metallic nature having a low carbon content and a high content of at least a precious metal such as Cr, Ni, Co and Mo.

The mixture is then supplied to a usual ceramic die for tiles and subjected to pressing at about 400 kg/cm².

After pressing and the usual drying cycles the tile is sent to the kiln for firing at a temperature comprised between 1200° C. and 1250° C.

Following firing the metal powder oxidises, becoming opaque and it is therefore necessary to subject the tile to an expensive sanding and polishing operation, with removal of about 0.8 mm thickness.

The oxidation of the metal powders which makes the following expensive and laborious sanding operation necesary also does not enable manufacture of natural tiles and surface-structured tiles, i.e. those having top surfaces which are not flat but irregular, such as quarry stone slabs.

The aim of the present invention is to obviate the drawbacks in the prior art in the ambit of a simple and rational solution.

The invention attains the set aims thanks to a manufacturing method which makes available ceramic tiles or slabs having brilliant speckled aesthetic effects without any need for sanding the tile following firing.

### BEST MODE FOR CARRYING OUT THE INVENTION

This result is obtained thanks to a mixture which comprises a mix of atomised powders and a mixture of alpha hematites.

The alpha hematites preferably exhibit a laminar crystalline structure, for example such as micaceous alpha hematites, which increase the brilliancy of the final product.

According to the type of product that is to be obtained, the percentage weight of the mixture of alpha hematites in the mixture varies from 0.2% to 40%; consequently the percentage weight of the mixture of the atomised ceramic powders varies between 99.8% and 60%.

Experimentally good results have been obtained with a percentage weight of the mixture of alpha hematites which is variable between 7% and 15%, and in particular with a percentage weight in the order of 10%.

In the invention, the granulometry of the mixture of alpha hematites should preferably have the following distribution:
2% being larger than 1000 μm,
40% being comprised between 600 and 1000 μm,
the remaining 58% being less than 600 μm.

The invention comprises the atomised ceramic powders being mixed with the mixture of alpha hematites by means of a mechanical mixer.

Thereafter the mixed powders are supplied in the form of a layer internally of a die of a forming die.

The mixture can be used to create the whole mass of the tile, but preferably its use is limited to a layer comprised between 3 and 6 mm of soft powder placed in the cavity of the die on the side of the tile destined to be in view. In this case the filling of the die is completed using usual clayey materials which will make up the substrate of the tile.

Once the die has been filled pressing is performed at a pressure comprised between 300 and 500 kg/cm². The tile thus formed is dried and fired in a kiln at a temperature of between 1200° C. and 1250° C.

During firing there is usually a shrinkage of the tile by about 8% and, the melting point temperature of alpha hematite being considerably higher than the firing temperature of vitrified stoneware, the alpha hematite powders rise to the in-view surface of the tile, giving the tile a surface roughness which is typical of natural stones. The alpha hematite also has the property of not oxidising during firing and thus the tile does not require sanding in order to remove the oxides which cover metal powders in the prior art.

A further advantage of the invention is due to the specific weight of alpha hematite, which is about 4.7-4.9 g/cm³, very much higher than the specific weight of atomised ceramic powder, about 0.9 g/cm³, which enables, during pressing, an easier and more rapid de-aeration of the die, facilitating a better compacting of the tile, and the rising of the alpha hematite to the in-view surface of the tile.

From tests carried out it has been observed that during supply of the mixture of powders internally of the die the alpha hematite powders, having a greater specific weight, tend to become arranged according to an oblique axis with respect to the horizontal surface of the bottom of the die. This means that once the tile has been fired the hematite powders risen to the surface of the tile, for the reasons set out herein above, are oblique with respect to the surface itself, which makes the tile more reflective of the light rays arriving from all directions.

The example that follows, given by way of non-limiting example, will better clarify the characteristics of the invention.

### EXAMPLE

The basic material comprises normally-used monochromatic atomised ceramic powder, having a granulometry of about 300 μm, in which a mixture of micaceous alpha hematites having laminar crystalline structure has been distributed by mechanical mixing.

The mixture of micaceous hematites comprises micaceous alpha hematites having various granulometries. In particular, 2% is larger than 1000 μm, 40% is comprised between 600 and 1000 μm, and the remaining 58% is less than 600 μm.

The micaceous hematite is supplied by KÄRNTNER MONTANINIDUSTRIE GmbH and is marketed under the name of micaceous iron oxide MIOX SG 1000, and has a melting point of 1560° C.

The mixture, which comprises 90% weight of ceramic powder and 10% of micaceous hematites, was supplied to a usual ceramic die for tiles and subjected to pressing at 400 kg/cm².

After pressing, the usual drying cycles and firing cycles at 1200° C.-1250° C. were performed.

The final tile obtained exhibited a surface having the colours of the mixture, on which there is a uniform distribution of shiny metallic speckles, randomly distributed.

1). A method for manufacturing vitrified stoneware ceramic tiles comprising following operations:
a. preparing a mixture comprising a mix of atomised ceramic powders and a mixture of alpha hematites;
b. depositing at least a first layer of the mixture internally of a die of a forming die;
c. pressing the mixture at a pressure comprised between 300 and 500 kg/cm²;
d. drying and firing the pressed mixture at a temperature of about 1200° C.-1250° C.

2). The method of claim 1, characterised in that the alpha hematites have a laminar crystalline structure.

3). The method of claim 1, characterised in that 2% of the mixture of alpha hematites has a granulometry which is greater than 1000 μm, 40% has a granulometry comprised between 600 and 1000 μm, and the remaining 58% has a granulometry which is less than 600 μm.

4). The method of claim 1, characterised in that the mixture comprises a percentage weight which is variable between 60% and 99.2% of atomised ceramic powders.

5). The method of claim 1, characterised in that the mixture comprises a percentage weight which is variable between 0.2% and 40% of alpha hematites.

6). The method of claim 1, characterised in that it places at least a second layer of clayey material internally of the die.

7). A ceramic slab comprising at least a layer of a mixture of atomised ceramic powders, characterised in that it further comprises a mixture of alpha hematites.

8). The ceramic slab of claim 7, characterised in that the hematites have a laminar crystalline structure.

9). The ceramic slab of claim 8, characterised in that the hematites are micaceous alpha hematites.

10). The ceramic slab of claim 7, characterised in that it further comprises a layer of clayey material.
